(19) United States
(12) Patent Application Publication
(10) Pub. No.: US 2018/0246666 A1
(43) Pub. Date: Aug. 30, 2018

(54) METHODS FOR PERFORMING DATA DEDUPLICATION ON DATA BLOCKS AT GRANULARITY LEVEL AND DEVICES THEREOF

(71) Applicant: NetApp, Inc., Sunnyvale, CA (US)

(72) Inventor: Manish Katiyar, Fremont, CA (US)

(21) Appl. No.: 15/442,323

(22) Filed: Feb. 24, 2017

(51) Int. Cl. G06F 3/06

(52) U.S. Cl. CPC G06F 3/0641; G06F 3/0673; G06F 3/0608

(57) ABSTRACT

A method, non-transitory computer readable medium, and device that assists with performing data deduplication on data blocks includes receiving a plurality of data blocks, wherein each of the received plurality of data blocks are of an equal memory size. Each of the received plurality of data blocks are split into a plurality of segments with a segment size less than the equal memory size. Duplicate data is identified within each of the plurality of segments for each of the received plurality of data blocks. One occurrence of the identified duplicate data is stored from each of the received plurality of data blocks into a new data block.

### FIELD

This technology generally relates to data storage management and, more particularly, methods for performing data deduplication on data blocks and devices thereof.

### BACKGROUND

Storage drives or disks provide an easy, fast, and convenient way for backing up or storing data. As additional backups are made, additional disks and disk space are required. However, disks or storage drives add costs to any backup solution including the costs of the disks themselves, costs associated with powering and cooling the disks, and costs associated with physically storing the disks in the datacenter. Thus, it becomes desirable to maximize the usage of disk storage available on each disk.

One method of maximizing storage on a disk is to use some form of data deduplication techniques. Data deduplication is a data compression technique for eliminating redundant data. In an existing deduplication process, first data is compared to stored data to detect duplicates, that is, to identify or determine whether the first data is unique or not. Next, when the first data is identified as not being unique, the redundant first data is eliminated and replaced with a small reference that points to the stored data. However, prior existing technologies only perform data deduplication by comparing the data present in one data block with the data present in another data block. Unfortunately, prior existing technologies fail to perform data deduplication in a single data block.

### BRIEF DESCRIPTION OF THE DRAWINGS

FIG. 1 is a block diagram of an environment with a storage management computing device that performs data deduplication on data blocks;

FIG. 2 is a block diagram of the exemplary storage management computing device shown in FIG. 1;

FIG. 3 is an exemplary flow chart of an example of a method for performing data deduplication on data blocks; and

FIGS. 4-7 are exemplary illustrations of performing data deduplication on data blocks.

### DETAILED DESCRIPTION

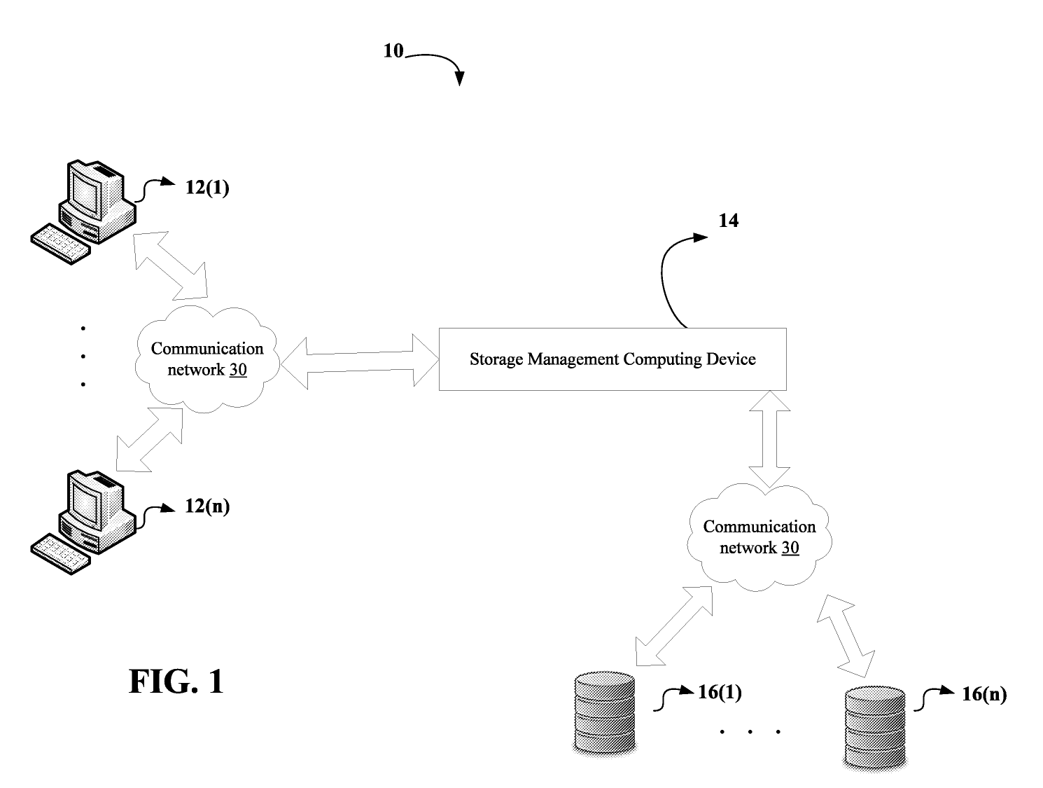

An environment 10 with a plurality of client computing devices 12(1)-12(n), an exemplary storage management computing device 14, a plurality of storage drives 16(1)-16(n) is illustrated in FIG. 1. In this particular example, the environment 10 in FIG. 1 includes the plurality of client computing devices 12(1)-12(n), the storage management computing device 14 and a plurality of storage drives 16(1)-16(n) coupled via one or more communication networks 30, although the environment could include other types and numbers of systems, devices, components, and/or other elements. The example of a method for performs data deduplication on data blocks is executed by the storage management computing device 14, although the approaches illustrated and described herein could be executed by other types and/or numbers of other computing systems and devices. The environment 10 may include other types and numbers of other network elements and devices, as is generally known in the art and will not be illustrated or described herein. This technology provides a number of advantages including providing methods, non-transitory computer readable media and devices for performing data deduplication on data blocks.

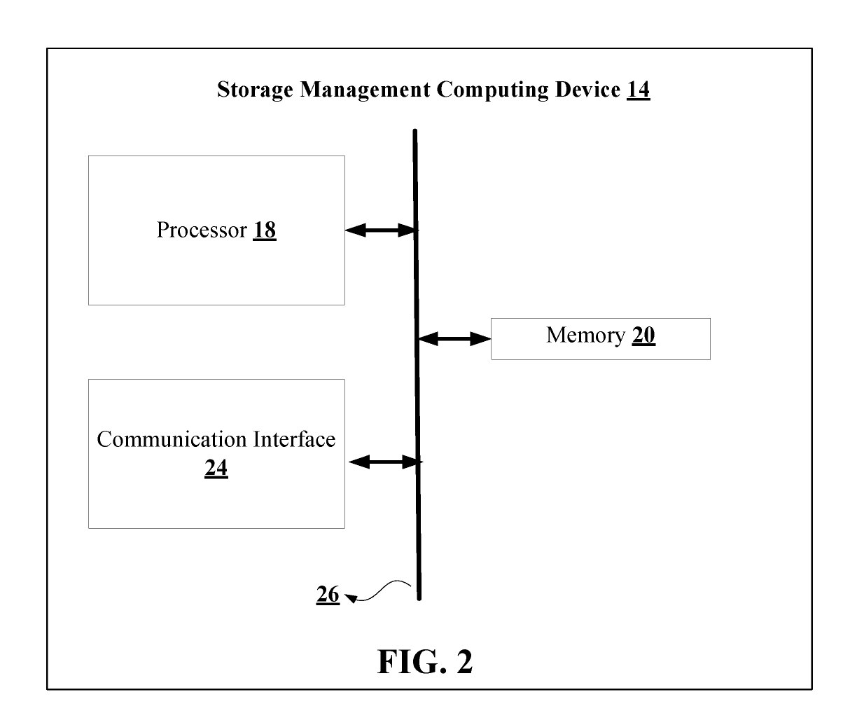

Referring to FIG. 2, in this example the storage management computing device 14 includes a processor 18, a memory 20, and a communication interface 24 which are coupled together by a bus 26, although the storage management computing device 14 may include other types and numbers of elements in other configurations.

The processor 18 of the storage management computing device 14 may execute one or more programmed instructions stored in the memory 20 for dynamic resource reservation based on classified input/output requests as illustrated and described in the examples herein, although other types and numbers of functions and/or other operation can be performed. The processor 18 of the storage management computing device 14 may include one or more central processing units (“CPUs”) or general purpose processors with one or more processing cores, such as AMD® processor(s), although other types of processor(s) could be used (e.g., Intel®).

The memory 20 of the storage management computing device 14 stores the programmed instructions and other data for one or more aspects of the present technology as described and illustrated herein, although some or all of the programmed instructions could be stored and executed elsewhere. A variety of different types of memory storage devices, such as a non-volatile memory, random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication interface 24 of the storage management computing device 14 operatively couples and communicates with the plurality of client computing devices 12(1)-12(n) and the plurality of storage drives 16(1)-16(n), which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, and an I/O system, which are coupled together by a bus or other link, although other numbers and types of network devices could be used. The plurality of client computing devices 12(1)-12(n) communicates with the storage management computing device 14 for storage management, although the client computing devices 12(1)-12(n) can interact with the storage management computing device 14 for other purposes. By way of example, the plurality of client computing devices 12(1)-12(n) may run application(s) that may provide an interface to make requests to access, modify, delete, edit, read or write data within storage management computing device 14 or the plurality of storage drives 16(1)-16(n) via the communication network 30.

Each of the plurality of storage drives 16(1)-16(n) includes a central processing unit (CPU) or processor, and an I/O system, which are coupled together by a bus or other link, although other numbers and types of network devices could be used. Each plurality of storage drives 16(1)-16(n) assists with storing data, although the plurality of storage drives 16(1)-16(n) can assist with other types of operations such as storing of files or data. Various network processing applications, such as CIFS applications, NFS applications, HTTP Web Data storage device applications, and/or FTP applications, may be operating on the plurality of storage drives 16(1)-16(n) and transmitting data (e.g., files or web pages) in response to requests from the storage management computing device 14 and the plurality of client computing devices 12(1)-12(n). It is to be understood that the plurality of storage drives 16(1)-16(n) may be hardware or software or may represent a system with multiple external resource servers, which may include internal or external networks.

Although the exemplary network environment 10 includes the plurality of client computing devices 12(1)-12(n), the storage management computing device 14, and the plurality of storage drives 16(1)-16(n) described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

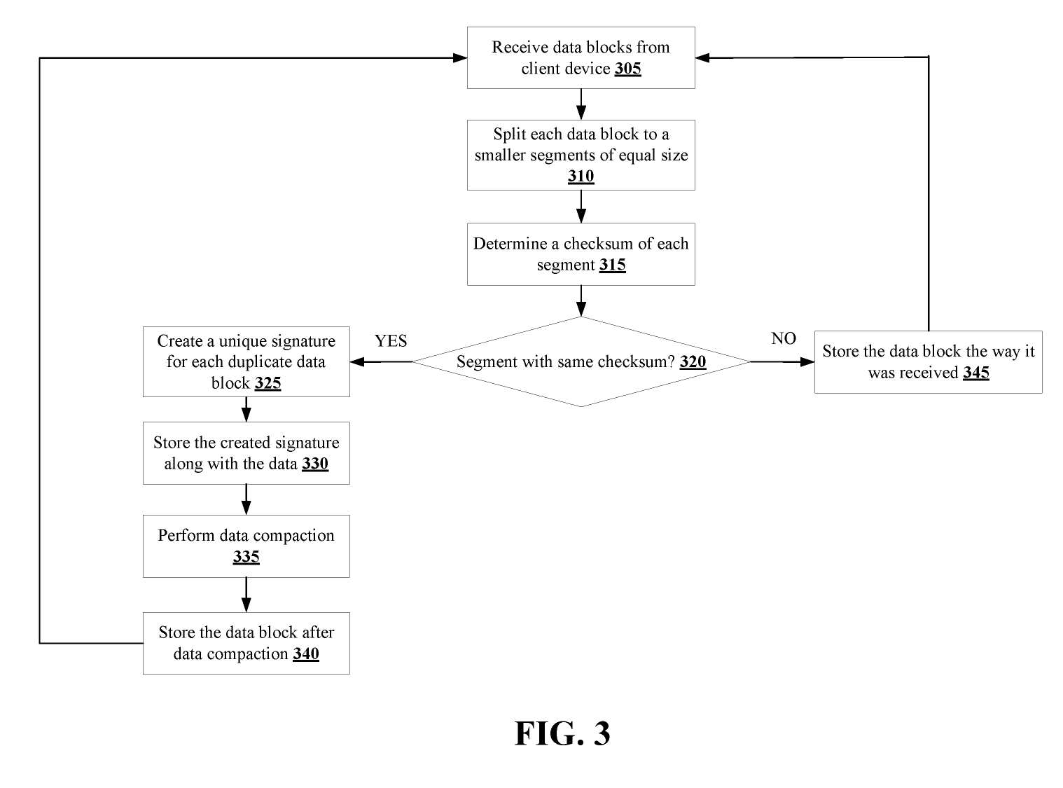

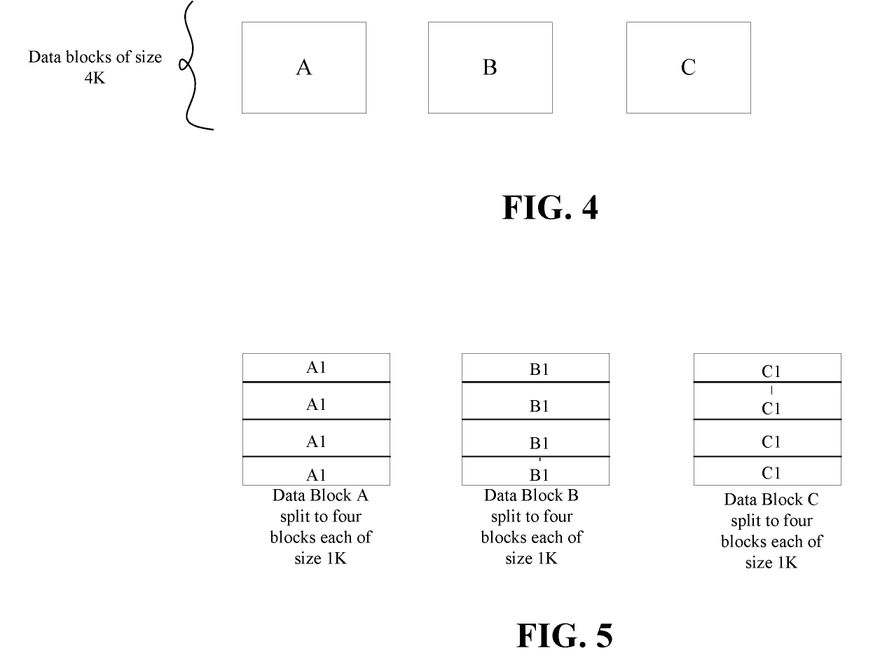

An example of a method for performing data deduplication on data blocks will now be described herein with reference to FIGS. 1-7. The exemplary method begins at step 305 where the storage management computing device 14 receives multiple blocks of data from one of the plurality of client computing devices 12(1)-12(n), although the storage management computing device 14 can receive other types and/or amounts of information. By way of example, the multiple data blocks A, B, and C each of size four kilo bytes received by the storage management computing device 14 is illustrated in FIG. 4.

Next in step 310, the storage management computing device 14 splits each data block to a granular size (segment size). By way of example, the granular size can be 512 bytes, 256 bytes, or 128 bytes, although the data block can be split into other different sizes. In this example, FIG. 5 illustrates each of the data block being split into 4 segments each of size one kilo byte (1K). The storage management computing device 14 performs this step of splitting the data block into granular size to identify the duplicate or repetitive data within each of the data block.

Next in step 315, the storage management computing device 14 determines a checksum for data in each segment within each of the data block. In this example with reference to FIG. 5, the storage management computing device 14 determines the checksum for each of the four segments of data block A, data block B, and data block C. Additionally in this example, the storage management computing device 14 can use a commonly available algorithm to calculate the checksum, which can be easily recognized by a person having ordinary skill in the art and therefore will not be illustrated in greater detail.

In step 320, the storage management computing device 14 compares the determined checksum of data in each segment of the data block to identify duplicate blocks of data within each of the data block. In this example, two segments having the same checksum value is determined to be duplicate blocks of data within the same data block. By way of example with reference to FIG. 5, the storage management computing device 14 compares the checksum value of the first segment A1 against the second segment A1, third segment A1 and the fourth segment A1. Similarly, the storage management computing device 14 compares the checksum for the segments in data block B, and data block C illustrated in FIG. 5. If during the comparison, when the storage management computing device 14 determines that the checksum value is equal, then the Yes branch is taken to step 325. By way of example, the checksum of the first segment, second segment, third segment and fourth segment of data block A would be the same because it includes the same data A1. Similar, the checksum of the first segment, second segment, third segment and fourth segment of data block B, and C would be the same because it includes the same content B1, and C1 respectively. Additionally in this example, the storage management computing device 14 can also perform a bit by bit comparison when the checksum of two segments is determined to be equal to confirm the duplicate or repetitive data within the data block.

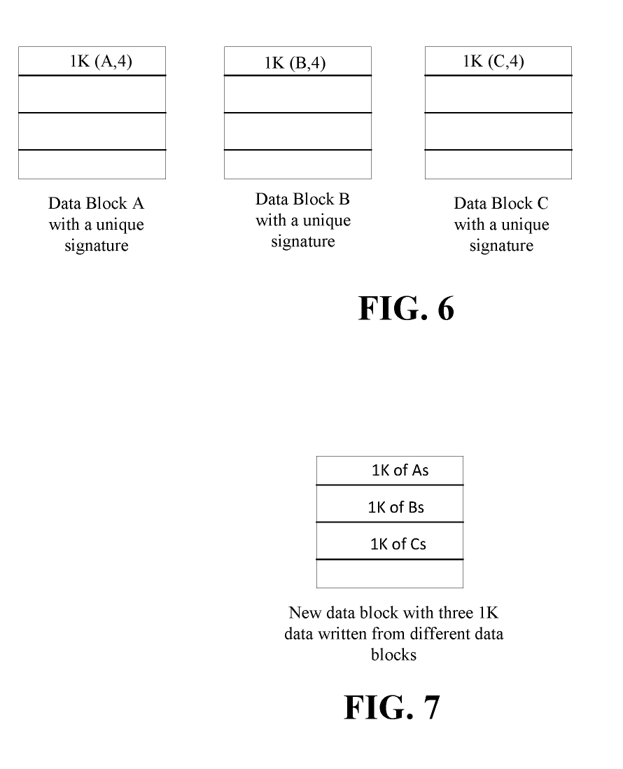

Next in step 325, the storage management computing device 14 creates a unique signature for each of the segment that is determined to have equal checksum for each of the data block that was received. By way of example with reference to FIG. 6, the storage management computing device 14 creates a unique signature for the segments of data block A as 1K (A,4) indicating that there is 1K of data in block A duplicated four times (or the same block of data is repeating four times within the data block), although the storage management computing device 14 can creates other types or amounts of signatures. Similarly, the storage management computing device 14 creates the unique signature for data block B as 1K (B,4), and for data block C as 1K(C,4). Additionally in this example, the uniquely created signature can also include the offset of the data that was originally stored in the received data block. Using this uniquely created signature, the technology can reconstruct the data block with duplicate or repetitive data to the full block (similar to the data that was received and as illustrated in FIGS. 4 and 5).

Next in step 330, the storage management computing device 14 stores the created signature in the header field of the data, although the storage management computing device 14 can store the created signature at other locations. When there is a request to either read or write the data block that was sent from one of the plurality of client computing devices 12(1)-12(n), the storage management computing device 14 can extract the signature that is stored in the header to reconstruct the full data block.

In step 335, the storage management computing device 14 performs data compaction on all four data blocks for which the signature was created. The technique of data compaction has been illustrated in the U.S. Publication No. 2017/0031614A1, which is hereby incorporated by reference in its entirety. By way of example, the result of data compaction of the four data blocks with signature is illustrated in FIG. 7. In this example, the duplicate data of each of the data block is consolidated to one instance of the duplicate data and each the instance of duplicate data of different data blocks are written to one single data block of size 4 k wherein the data block includes four segments. By way of example with reference to FIG. 5, the data A1 is the duplicate data repeating four times in the data block A and similarly, data B1 is duplicate data repeating four times in data block B, and data C1 repeating in data block C. The previous step 330 creates a signature of the duplicate data and reduces the data repeating four times to a single instance of data along with the signature. As illustrated in FIG. 6, data block A includes one instance of size 1K of data A1 and similarly, one instance of size 1K of data B11, and one instance of size. By performing data compaction, the 1K size of data in each of the data block is written to a new data block of size 4K with four 1K segments.

Next in step 340, the storage management computing device 14 stores the data blocks in the data compacted form in the plurality of storage drives 16(1)-16(n) as illustrated in FIG. 7, although the storage management computing device 14 can store the data blocks at other memory locations. By storing the data blocks in the data compacted format, the technology is able to significantly reduce the amount of storage space required to store the received data blocks. By way of example, if the storage management computing device 14 had stored the data blocks that was originally received in step 305 and as represented in FIGS. 4 and 5, three blocks of data would be required in the plurality of storage drives 16(1)-16(n) to store the data block. However, by splitting the received data block to granular size, determining the checksum, creating the signature and performing data compaction, the technology is able to store in received three blocks of data as just one block of data in the plurality of storage drives 16(1)-16(n). The exemplary flow proceeds back to step 305 where the storage management computing device 14 receives the next set of data blocks from the plurality of client computing devices 12(1)-12(n). Additionally in this example, the storage management computing device 14 can create a bitmap of the location at which the data block was stored in the storage drives 16(1)-16(n) and the corresponding created signature of the data blocks. This data in the bitmap can be used to reconstruct the data block when there is a request for reading or writing the data from the plurality of client computing devices 12(1)-12(n).

However, if back in step 320, when the storage management computing device 14 determines that segments of the data blocks does not have the same checksum, then the No branch is taken to step 345. In this example, when the checksum of the two segments within the same data block does not match, it indicates that the data in the segments of the same block are not duplicate or repetitive data.

In step 345, the storage management computing device 14 stores data blocks in the format that was received in the plurality of storage drives 16(1)-16(n), although the storage management computing device 14 can store the received blocks of data in other formats and other memory locations. The exemplary flow of the method then proceeds back to step 305 where the storage management computing device 14 receives the next data blocks from the plurality of client computing devices 12(1)-12(n).

Accordingly, as illustrated and described by way of the examples herein, this technology provides a number of advantages including providing methods, non-transitory computer readable media and devices for performing deduplication on data blocks. Using the above illustrated examples, the disclosed technology is able to significantly reduce the storage space of the data blocks in the storage drives thereby managing the memory space in a more efficient manner. Alternatively, the disclosed technology can also be used to perform deduplication at granularity level even in cases where the full filesystem block is not full of same pattern.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
receiving, by a computing device, a plurality of data blocks, wherein each of the received plurality of data blocks are of an equal memory size;
splitting, by the computing device, each of the received plurality of data blocks into a plurality of segments with a segment size less than the equal memory size;
identifying, by the computing device, duplicate data within each of the plurality of segments for each of the received plurality of data blocks; and
storing, by the computing device, one occurrence of the identified duplicate data from each of the received plurality of data blocks into a new data block.

2. The method as set forth in claim 1 further comprising, creating, by the computing device, a unique signature for the identified duplicate data in the plurality of segments for each of the plurality of data blocks.

3. The method as set forth in claim 2 further comprising, storing, by the computing device, the created unique signature in a header field of the one occurrence of duplicate data stored in the new data block.

4. The method as set forth in claim 1 wherein identifying further comprises:
determining, by the computing device, a checksum value for stored data each of the plurality of segments; and
identifying, by the computing device, stored data in the plurality of segments as the duplicate data when the checksum value of one of the plurality of segments is equal to the checksum value of another one of the plurality of segments.

5. A non-transitory computer readable medium having stored thereon instructions for performing data deduplication on data blocks comprising executable code which when executed by a processor, causes the processor to perform steps comprising:
receiving a plurality of data blocks, wherein each of the received plurality of data blocks are of an equal memory size;
splitting each of the received plurality of data blocks into a plurality of segments with a segment size less than the equal memory size;
identifying duplicate data within each of the plurality of segments for each of the received plurality of data blocks; and
storing one occurrence of the identified duplicate data from each of the received plurality of data blocks into a new data block.

6. The medium as set forth in claim 5 further comprising, creating a unique signature for the identified duplicate data in the plurality of segments for each of the plurality of data blocks.

7. The medium as set forth in claim 6 further comprising, storing the created unique signature in a header field of the one occurrence of duplicate data stored in the new data block.

8. The medium as set forth in claim 5 wherein identifying further comprises:
determining a checksum value for stored data each of the plurality of segments; and
identifying stored data in the plurality of segments as the duplicate data when the checksum value of one of the plurality of segments is equal to the checksum value of another one of the plurality of segments.

9. A storage management computing device comprising:
a processor;
a memory coupled to the processor which is configured to be capable of executing programmed instructions comprising and stored in the memory to:
receive a plurality of data blocks, wherein each of the received plurality of data blocks are of an equal memory size;
split each of the received plurality of data blocks into a plurality of segments with a segment size less than the equal memory size;
identify duplicate data within each of the plurality of segments for each of the received plurality of data blocks; and
store one occurrence of the identified duplicate data from each of the received plurality of data blocks into a new data block.

10. The device as set forth in claim 9 wherein the processor coupled to the memory is further configured to be capable of executing at least one additional programmed instruction comprising and stored in the memory to create a unique signature for the identified duplicate data in the plurality of segments for each of the plurality of data blocks.

11. The device as set forth in claim 10 wherein the processor coupled to the memory is further configured to be capable of executing at least one additional programmed instruction comprising and stored in the memory to store the created unique signature in a header field of the one occurrence of duplicate data stored in the new data block.

12. The device as set forth in claim 9 wherein the processor coupled to the memory is further configured to be capable of executing at least one additional programmed instruction comprising and stored in the memory wherein identifying further comprises:
determine a checksum value for stored data each of the plurality of segments; and
identify stored data in the plurality of segments as the duplicate data when the checksum value of one of the plurality of segments is equal to the checksum value of another one of the plurality of segments.
